(19) United States
(12) Patent Application Publication
(10) Pub. No.: US 2021/0205639 A1
(43) Pub. Date: Jul. 8, 2021

(54) ROPE BRAKING DEVICE

(71) Applicant: Hsiu-Yang Tseng, Taipei City (TW)

(72) Inventor: Hsiu-Yang Tseng, Taipei City (TW)

(21) Appl. No.: 16/734,417

(22) Filed: Jan. 6, 2020

(51) Int. Cl. A62B 1/10; A62B 1/14

(52) U.S. Cl. CPC A62B 1/10; A62B 1/14

(57) ABSTRACT

A rope braking device includes a base, a one-way pulley, a handle, and a clamping part. The base has a guiding slot extends along a curve path. The one-way pulley is disposed on the base and is rotatable in a direction about a rotation center. A distance that is defined from the rotation center to the curve path is variable and has a relative minimum corresponding to a position of the curve path. The handle is pivotally connected to the base and has another guiding slot. The clamping part is slidably disposed in the two guiding slots simultaneously and opposite to the one-way pulley. When the handle pivots to move the clamping part to the position, a rope wound around the one-way pulley is compressed by the one-way pulley and the clamping part, so that the rope is movable in the direction and is unmovable in the reverse direction.

### BACKGROUND OF THE INVENTION

### 1. Field of the Invention

The invention relates to a descender and a pulley, and especially relates to a descender and a pulley with a braking function.

### 2. Description of the Prior Art

A conventional pulley is composed of a wheel that is surrounded by a rope when in use to hoist or lower a load attached to the rope. The wheel is freely rotatable, so the movement (including lowering and hoisting) of the load on the rope is controlled usually by user's hands only. To prevent the load from freely falling, a one-way pulley in coordination with a cam may be used to allow the rope to roll only in one direction and completely stop in another direction by controlling the orientation of the cam relative to the one-way pulley. However, the conventional pulley or one-way pulley cannot support users in lowering loads with controlled speed in principle. In a conventional descender, the friction between a rope and the descender is induced by a compression of the rope by the descender and can control the speed of lowering. However, the friction impedes all movement of the rope in lowering and hoisting. Therefore, a device for pulley and vertical activities that allows users to not only control descending speed but also allow unhindered ascending is in demand.

### SUMMARY OF THE INVENTION

An objective of the invention is to provide a rope braking device which allows users to control the movement of a rope wound through the rope braking device relative to the rope braking device by adjusting a distance for a compression of the rope.

A rope braking device according to the invention includes a base, a one-way pulley, a handle, and a clamping part. The base includes a base body and a first guiding slot formed on the base body. The base body thereon defines a rotation center. The first guiding slot extends along a curve path. A distance that is defined from the rotation center to the curve path is variable and has a relative minimum corresponding to a position of the curve path. The one-way pulley is disposed on the base body at the rotation center and has a rotary wheel. The rotary wheel is rotatable in a rotation direction. The handle is pivotally connected to the base body and has a second guiding slot. The clamping part is slidably disposed in the first guiding slot and the second guiding slot simultaneously. The clamping part has a clamping surface opposite to a peripheral surface of the rotary wheel. Therein, a rope is capable of being wound around the rotary wheel and between the peripheral surface and the clamping surface. When the handle is operable to pivot relative to the base body to make the clamping part move toward the position until the rope is compressed by the peripheral surface and the clamping surface, the rope is unmovable in a braking direction opposite to the rotation direction and is movable in the rotation direction. Further, when the clamping part moves to another position of the curve path corresponding to a larger distance from the rotation center to the curve path such that the clamping part applies a less compressing force to the rope, the rope can be moved in the braking direction in a smaller speed than in the rotation direction under the same pulling force to the rope.

Compared with the prior art, the rope braking device according to the invention uses a simple mechanism to allow the rope to be movable in one direction and unmovable in the other direction without a cam or other complicated mechanisms (e.g. which may include levels, springs, gears and so on). The rope braking device controls the movement of the rope by adjusting a distance for a compression of the rope by a user operating the handle; therein, it is unnecessary to apply a force to the rope or to slide the rope in advance for the compression of the rope. Furthermore, the curved guiding slot of the base body of the rope braking device is conducive to distributing a reaction force by the compressed rope to the curved guiding slot through the clamping part, so that a portion of the reaction force to the handle through the clamping part can be reduced so as to maintain the position of the handle. Thereby, the rope braking device also can allow the rope to be moved in both directions but in different speeds. In practice, when serving as a descender, the rope braking device can allow a user to control the descending speed; when serving as a pulley for lifting a load, the rope braking device allows a user to pull the rope for lifting the load and prevents the load from freely falling.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a rope braking device of an embodiment according to the invention; therein, a cover of the rope braking device is rotated away to show the interior of the rope braking device, and the cover which is located where to cover the interior of the rope braking device is shown in dash lines.

FIG. 2 is a partially exploded view of the rope braking device in FIG. 1.

FIG. 3 is a front view of the rope braking device in FIG. 1 without the cover thereof.

FIG. 4 is a schematic diagram illustrating the rope braking device in FIG. 3 with a rope wound through the rope braking device and the clamping part located at a first position.

FIG. 5 is a schematic diagram illustrating the rope braking device in FIG. 3 with the rope wound through the rope braking device and the clamping part located at a second position.

FIG. 6 is a schematic diagram illustrating the rope braking device in FIG. 3 with the rope wound through the rope braking device and the clamping part located at a fourth position.

FIG. 7 is a schematic diagram illustrating the rope braking device in FIG. 3 with the rope wound through the rope braking device and the clamping part located at a third position.

FIG. 8 is a schematic diagram illustrating the rope braking device used according to another embodiment; therein, the cover of the rope braking device is rotated away to show the interior of the rope braking device.

FIG. 9 is a front view of the rope braking device in FIG. 8 without the cover thereof.

### DETAILED DESCRIPTION

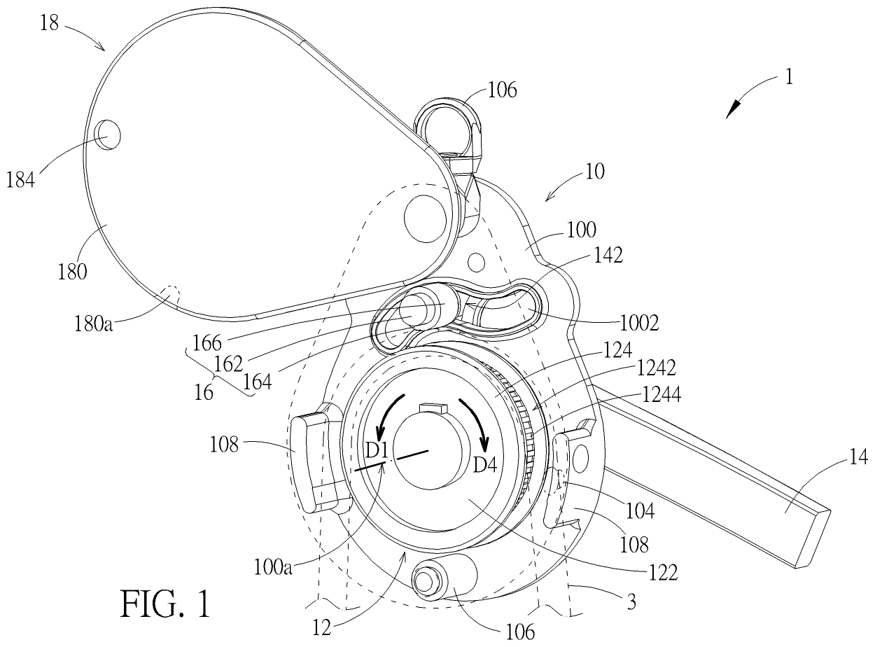

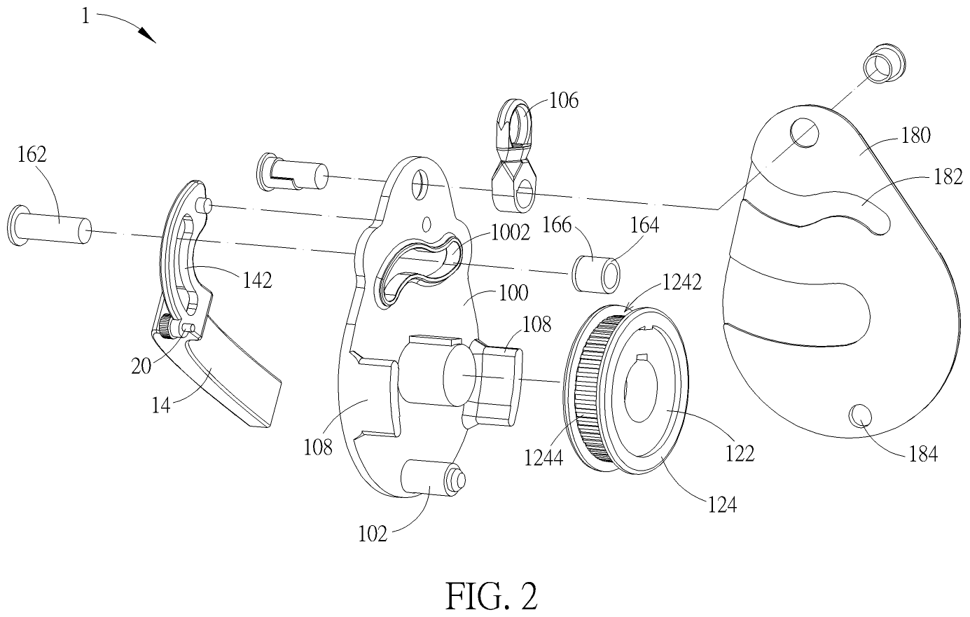

Please refer to FIG. 1 and FIG. 2. A rope braking device 1 of an embodiment according to the invention includes a base 10, a one-way pulley 12, a handle 14, a clamping part 16, and a cover 18. The base 10 includes a base body 100 and a first guiding slot 1002 formed on the base body 100. The first guiding slot 1002 extends along a curve path 1006. The base body 100 thereon defines a rotation center 100a (indicated by a dash-dot line in FIG. 1 and FIG. 2). The one-way pulley 12 is disposed on the base body 100 at the rotation center 100a. The handle 14 is pivotally connected to the base body 100 and has a second guiding slot 142. The clamping part 16 is configured to pass through the first guiding slot 1002 and the second guiding slot 142 and slidably disposed in the first guiding slot 1002 and the second guiding slot 142 simultaneously. The clamping part 16 is also opposite to the one-way pulley 12. The cover 18 is pivotally connected to the base body 100, so that the one-way pulley 12 is located between the cover 18 and the base body 100. A rope 3 (shown by dash lines in FIG. 1) is capable of being wound through the rope braking device 1 and passing between the one-way pulley 12 and the clamping part 16. A user can operate the handle 14 to move the clamping part 16 so as to adjust the relative position of the clamping part 16 to the one-way pulley 12, so that the clamping force applied to the rope 3 by the clamping part 16 and the one-way pulley 12 and the friction induced by the clamping force are adjusted accordingly. Thereby, the allowable movement speed of the rope 3 can be controlled.

For more details, the one-way pulley 12 includes a one-way bearing 122 and a rotary wheel 124 fitted on the one-way bearing 122. In practice, the one-way bearing 122 has an inner ring, an outer ring, and a braking mechanism for confining the outer ring to be able to rotate only in one direction. The one-way bearing 122 can be achieved by a conventional one-way bearing and will not be described further. The inner ring is mounted on the base body 100, e.g. by being fitted on a shaft mounted on the base body 100 or by a screw locking the inner ring on the base body 100, and the rotary wheel 124 is fitted on the outer ring, so that the rotary wheel 124 is rotatable in a rotation direction D1 (indicated by an arrow in FIG. 1) relative to the base body 100. The rotary wheel 124 has a peripheral surface 1242. The rope 3 is wound around the peripheral surface 1242. Furthermore, in the embodiment, the rotary wheel 124 is provided with a groove between two flanges on the peripheral surface 1242 of the rotary wheel 124, which facilitates the stability of the rope 3 wound around the rotary wheel 124. However, the invention is not limited to thereto. For example, the one-way pulley 12 can be achieved by one one-way bearing 122; therein, the outer ring thereof directly functions as the rotary wheel 124 and can be processed to form a groove on its peripheral surface for the disposition of the rope 3.

Furthermore, the clamping part 16 includes a shaft 162 and a rotary rim 164. The shaft 162 passes through the first guiding slot 1002 and the second guiding slot 142 and is movable along the first guiding slot 1002 and the second guiding slot 142 simultaneously. The rotary rim 164 is rotatably disposed on the shaft 162 and has a clamping surface 166 opposite to the peripheral surface 1242 of the rotary wheel 124. The rope 3 passes between the rotary rim 164 and the rotary wheel 124 (or between the peripheral surface 1242 and the clamping surface 166). Such configuration is conducive to that the rotary rim 164 can rotate as the rope 3 moves, so that in principle there is no relative slip between the rope 3 and the rotary rim 164. In practice, the clamping part 16 can be achieved by a conventional bearing fitted on a shaft; therein, the outer ring of the bearing functions as the rotary rim 164. In an instance, the clamping part 16 can be achieved by a rod passing through the first guiding slot 1002 and the second guiding slot 142 simultaneously if there is no or negligible friction between the rope 3 and the rod; therein, a peripheral surface of the rod can function as the clamping surface 166.

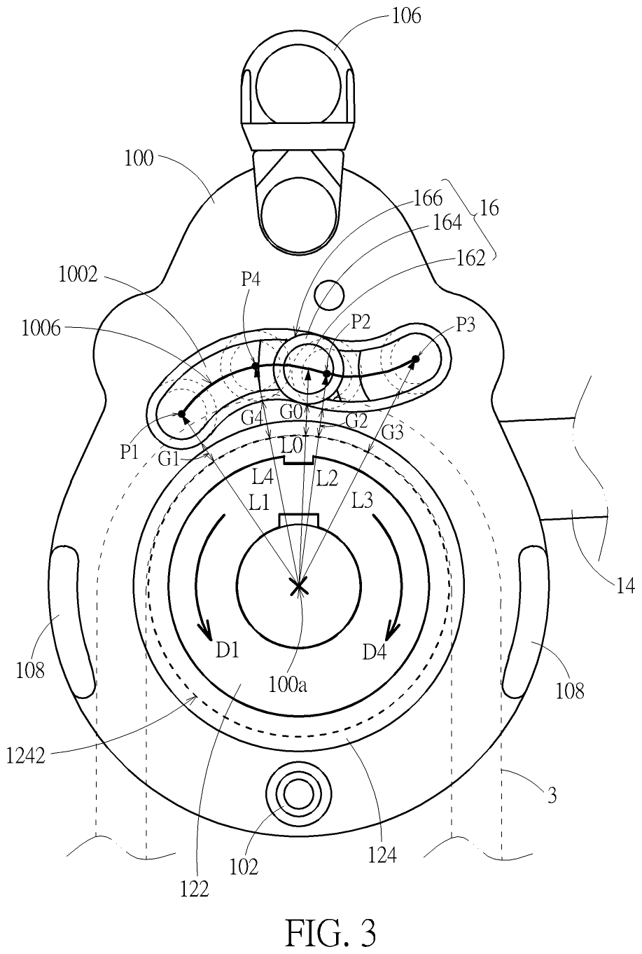

Please also refer to FIG. 3. Furthermore, the curve path 1006 is indicated by a bold line in FIG. 3. A distance L0 that is defined from the rotation center 100a to the curve path 1006 is variable; that is, the distance L0 varies as a distance is measured from the rotation center 100a (indicated by a cross mark in FIG. 3) to different positions of the curve path 1006. The distance L0 has a first relative minimum L1 corresponding to a first position P1 of the curve path 1006, a second relative minimum L2 corresponding to a second position P2 of the curve path 1006, a first relative maximum L3 corresponding to a third position P3 of the curve path 1006, and a second relative maximum L4 corresponding to a fourth position P4 of the curve path 1006; therein, the positions P1 to P4 are indicated by spots in FIG. 3. The first position P1 is located at an end of the curve path 1006. The fourth position P3 is located at the other end of the curve path 1006. The second position P2 is located between the first position P1 and the third position P3. The fourth position P4 is located between the first position P1 and the second position P2. In another aspect, the second position P2 and the fourth position P4 are located within a middle section of the curve path 1006.

In the embodiment, as the distance L0 decreases, the gap G0 between the clamping surface 166 and the peripheral surface 1242 (shown in hidden lines in FIG. 3) decreases, so that the clamping force applied to the rope 3 by the clamping part 16 and the one-way pulley 12 through the clamping surface 166 and the peripheral surface 1242 increases; similarly, as the distance L0 increases, the gap G0 between the clamping surface 166 and the peripheral surface 1242 increases, so that the clamping force applied to the rope 3 by the clamping part 16 and the one-way pulley 12 through the clamping surface 166 and the peripheral surface 1242 decreases. Therefore, in the embodiment, the gap G0 will reach a relative minimum G1 or G2 as the clamping part 16 (shown by dashed circles) moves to the first position P1 or the second position P2 respectively; the gap G0 will reach a relative maximum G3 or G4 as the clamping part 16 (shown by dashed circles) moves to the third position P3 or the fourth position P4 respectively.

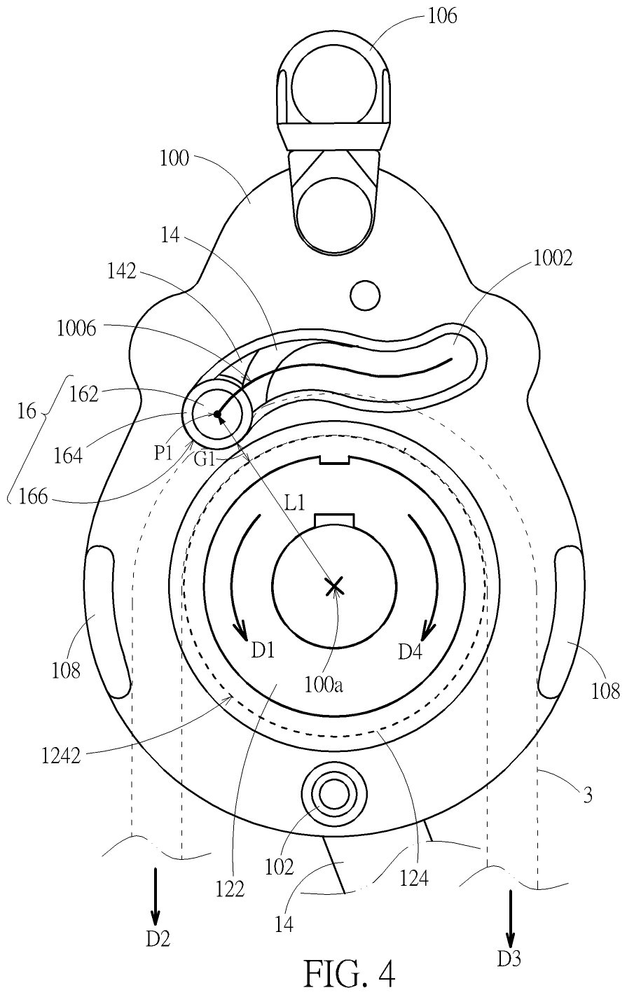

Please refer to FIG. 3 and FIG. 4. As shown by FIG. 4, the clamping part 16 is moved to the first position P1 (by operating the handle 14 to pivot relative to the base body 100). The gap (i.e. the relative minimum G1) is smaller than the size of the rope 3, so the rope 3 is compressed by the peripheral surface 1242 and the clamping surface 166. In practice, if the size of the rope 3 is so large that the clamping part 16 hardly moves to the first position P1, a user still can make the rope 3 be effectively compressed by the peripheral surface 1242 and the clamping surface 166 by operating the handle 14 to pivot relative to the base body 100 to make the clamping part 16 move toward the first position P1 until the rope 3 is compressed by the peripheral surface 1242 and the clamping surface 166. For simplification of the description about the use of the rope braking device 1, the embodiment is based on that the clamping part 16 can move to the first position P1 where the rope 3 is compressed tightly by the peripheral surface 1242 and the clamping surface 166.

At the moment, when the rope 3 is pulled in a direction D2 (indicated by an arrow in FIG. 4) i.e. along the rotation direction D1, because the rotary wheel 124 is allowed to rotate in the rotation direction D1 (i.e. counterclockwise in the view of FIG. 4) and the rotary rim 164 is allowed to rotate in both directions, the rope 3 can be moved in the direction D2. It is noted that although the rope 3 can be moved in the direction D2, both the rotary wheel 124 and the rotary rim 164 apply friction forces to the rope 3. In principle, the friction forces can be overcome or neglected because the friction between the rope 3 and each of the rotary wheel 124 and the rotary rim 164 is of rolling friction.

Furthermore, when the rope 3 is pulled in a direction D3 (indicated by an arrow in FIG. 4) i.e. along a braking direction D4 (indicated by an arrow in FIG. 4) opposite to the rotation direction D1, because the rotary wheel 124 is unmovable in the braking direction D4, slip friction will occur between the rotary wheel 124 and the rope 3 if the rope 3 is moved relative to the rotary wheel 124. Therefore, the friction force applied by the rotary wheel 124 to the rope 3 is significant and cannot be ignored. In the embodiment, the gap (i.e. the relative minimum G1) is designed to make the friction force applied by the rotary wheel 124 to the rope 3 to be larger than any pulling force applied by a user to the rope 3 (before the rope 3 fractures); that is, the rope 3 is unmovable in the braking direction D4 (or the direction D3). In other words, in the case shown by FIG. 4, the rope 3 is unmovable in the braking direction D4 when the rope 3 is pulled along the braking direction D4 and the rope 3 is movable in the rotation direction D1 when the rope 3 is pulled along the rotation direction D1.

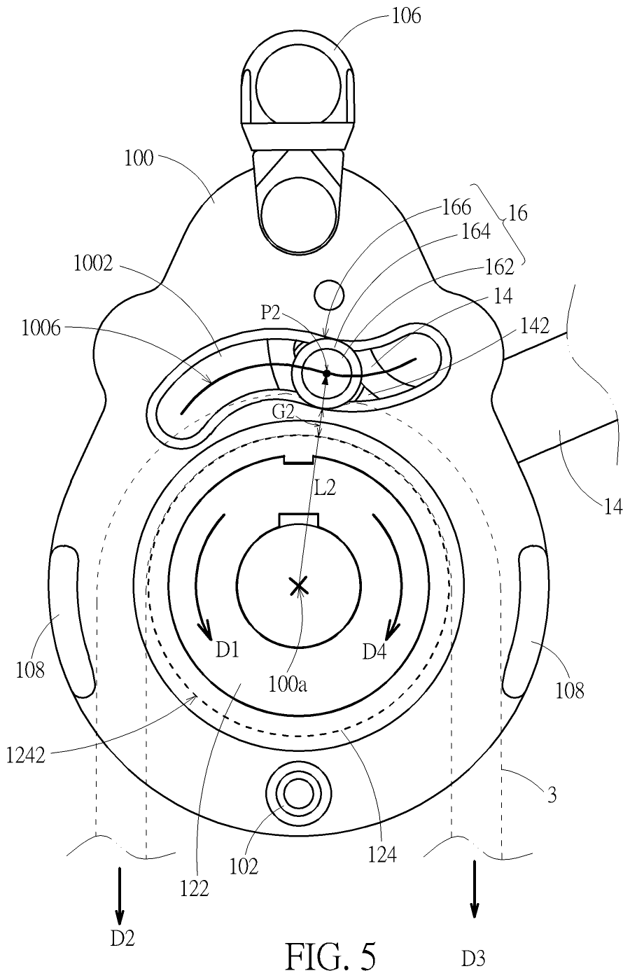

Please refer to FIG. 3 and FIG. 5. As shown by FIG. 5, the clamping part 16 is moved to the second position P2 (by operating the handle 14 to pivot relative to the base body 100). The gap (i.e. the relative minimum G2) is smaller than the size of the rope 3, so the rope 3 is compressed by the peripheral surface 1242 and the clamping surface 166. Similar to the above description about the action of the rope 3 moving in the direction D2, in sum, the rope 3 can be moved in the direction D2. Furthermore, in the embodiment, the gap G2 is designed to be slightly smaller than the gap G1 but still smaller than the size of the rope 3 so that the rope 3 still can be compressed by the peripheral surface 1242 and the clamping surface 166 when the clamping part 16 is located at the second position P2, which facilitates a movement of the clamping part 16 across the second position P2 toward the first position P1 when the rope 3 is wound around the rotary wheel 124. However, in practice, the gap G2 can be designed to be equal to the gap G1. In this case, similar to the above description about the action of the rope 3 moving in the direction D3 for the case of FIG. 4, the rope 3 is unmovable in the braking direction D4.

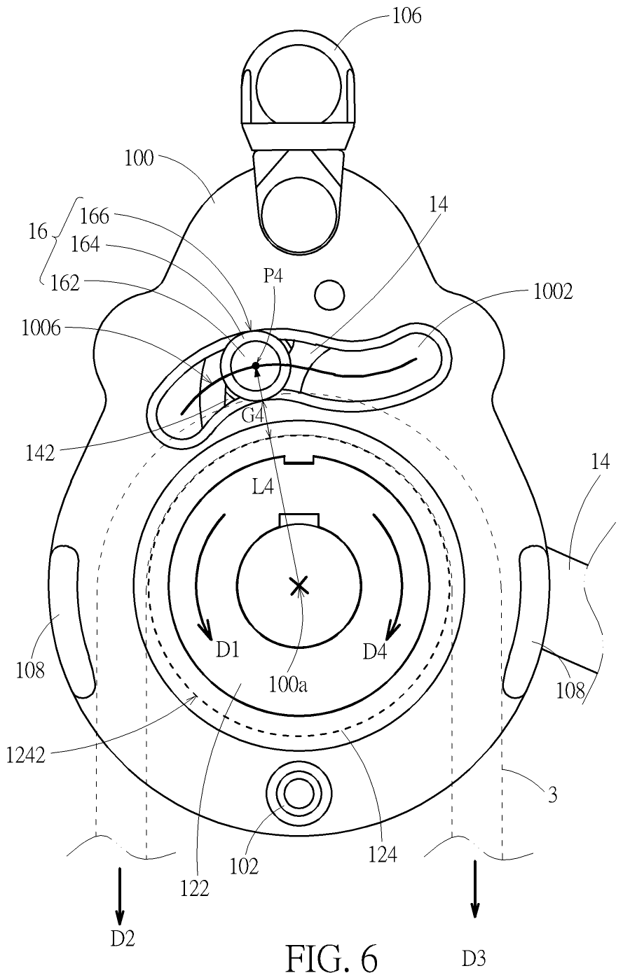

Please refer to FIG. 3 and FIG. 6. As shown by FIG. 6, the clamping part 16 is moved to the fourth position P4 (by operating the handle 14 to pivot relative to the base body 100). In the embodiment, the gap (i.e. the relative maximum G4) is still smaller than the size of the rope 3, so the rope 3 is compressed by the peripheral surface 1242 and the clamping surface 166; besides, the clamping force applied by the peripheral surface 1242 and the clamping surface 166 to the rope 3 corresponding to the clamping part 16 located at the fourth position P4 is much smaller than that corresponding to the clamping part 16 located at the first position P1 or the second position P2. Similar to the above description about the action of the rope 3 moving in the direction D2, in sum, the rope 3 can be moved in the direction D2.

Furthermore, when the rope 3 is pulled in the direction D3 (i.e. along a braking direction D4), because the rotary wheel 124 is unmovable in the braking direction D4, slip friction will occur between the rotary wheel 124 and the rope 3 if the rope 3 is moved relative to the rotary wheel 124. In the embodiment, the gap (i.e. the relative maximum G4) is designed to make the friction force applied by the rotary wheel 124 to the rope 3 not to be so large that the rope 3 cannot move in the braking direction D4 (or the direction D3). In other words, in the case shown by FIG. 6, the rope 3 is movable in both the braking direction D4 and the rotation direction D1; therein, under the same pulling force applied to the rope 3, the speed of the rope 3 moving in the rotation direction D1 (or the direction D2) is significantly larger than the speed of the rope 3 moving in the braking direction D4 (or the direction D3). The difference of speed in different directions is mainly based on the friction force applied to the rope 3 by the rotary wheel 124 and can be modified by adjusting the gap (i.e. the relative maximum G4) or the contact interface condition (e.g. the peripheral surface 1242 and the surface of the rope 3). In the embodiment, the one-way pulley 12 includes a plurality of grooves 1244 formed on the peripheral surface 1242 and extending perpendicular to the rotation direction D1 (equivalent to a direction perpendicular to the paper of FIG. 6). The grooves 1244 can enlarge the difference of speed in different directions. However, the invention is not limited thereto. For example, the peripheral surface 1242 can be a rough surface instead of the grooves 1244. The rough surface can be achieved by a microstructure or a knurling pattern formed on the peripheral surface 1242. In addition, for most cases, even when the peripheral surface 1242 is visually smooth, the peripheral surface 1242 also can offer enough friction force without excessive normal force.

Please refer to FIG. 3. Based on the above descriptions, when the clamping part 16 is located between the first position P1 and the second position P2, the rope 3 is compressed by the peripheral surface 1242 and the clamping surface 166 and the rope 3 is movable in both the rotation direction D1 (i.e. the direction D2) and the braking direction D4 (i.e. the direction D3). The difference of speed in different directions is affected by the gap between peripheral surface 1242 and the clamping surface 166. In principle, the difference of speed in different directions increases as the gap decreases, and the difference of speed in different directions decreases as the gap increases. In the embodiment, a user can adjust the speed of the rope 3 moving in the braking direction D4 by operating the handle 14 to pivot relative to the base body 100 to make the clamping part 16 slide in the first guiding slot 1002 and the second guiding slot 142 simultaneously to a desired position for obtaining a desired compressing force (or the friction force applied to the rope 3). In addition, in practice, the curve path 1006 also can be designed such that the gaps around the fourth position P4 are slightly larger than the size of the rope 3. In this case, the gap G4 is larger than the size of the rope 3. The different of speed in different directions corresponding to the fourth position P4 is almost zero or negligible.

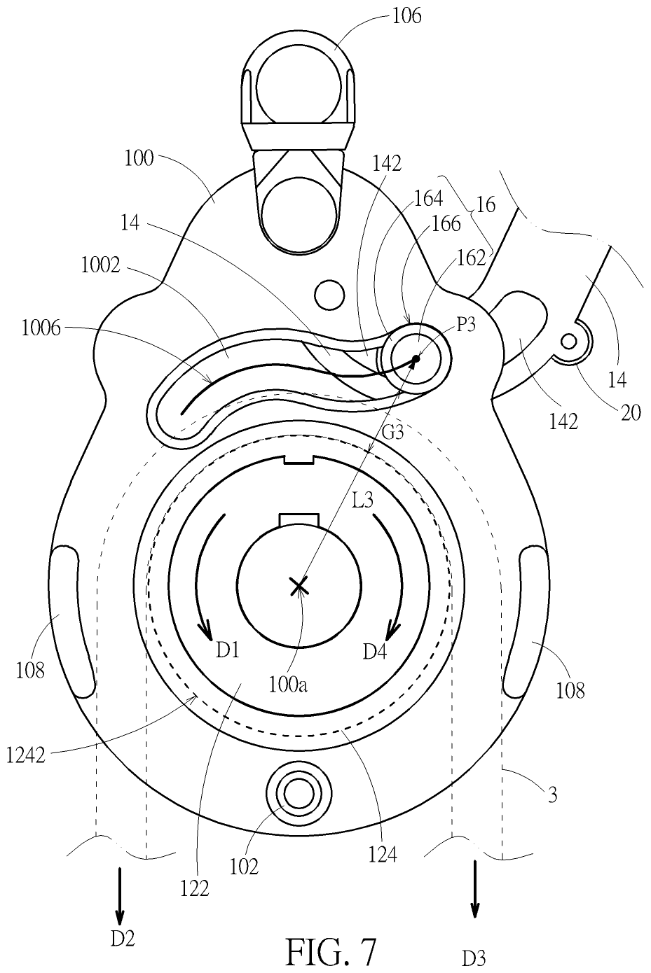

Please refer to FIG. 3 and FIG. 7. As shown by FIG. 7, the clamping part 16 is moved to the third position P3 (by operating the handle 14 to pivot relative to the base body 100). The gap (i.e. the relative maximum G3) is much larger than the size of the rope 3, so the rope 3 is free of the clamping surface 166; that is, the rope 3 will not be compressed by the peripheral surface 1242 and the clamping surface 166. In principle, the rope 3 is movable in both the braking direction D4 and the rotation direction D1. In practice, when the clamping part 16 is moved to the third position P3, it is convenient for a user to install or uninstall the rope 3.

In addition, in the embodiment, the curve path 1006 is designed to produce two braking positions (i.e. the first position P1 and the second position P2), an open position (i.e. the third position P3), and an adjustment position range (i.e. a set of positions between the first position P1 and the second position P2); however, the invention is not limited thereto. Furthermore, in the embodiment, the distances corresponding to the first position P1 and the second position P2 are designed but not limited to be almost the same. The fourth position P4 is designed but not limited to make the rope 3 is still compressed by the clamping surface 166 and the peripheral surface 1242 at the fourth position P4. In practice, the design of the curve path (includes the number of relative minimums and maximums of the distance between from the rotation center to the curve path) for a rope braking device according to the invention may depend on user's request, especially by actual use purposes. In practice, the curved guiding slot 1002 of the base body 100 of the rope braking device 1 is conducive to distributing a reaction force by the compressed rope 3 to the curved guiding slot 1002 through the clamping part 16, so that a portion of the reaction force to the handle 14 through the clamping part 16 can be reduced so as to maintain the position of the handle 14. Furthermore, in the embodiment, an adjustment screw 20 (shown in FIG. 2) is provided for increasing drag (e.g. a friction force) against the movement of the handle 14, which is conducive to holding the handle 14 relative to the base body 100 for overcoming the portion of the reaction force to the handle 14 while the user stops rotating the handle 14. The adjustment screw 20 is adjustably screwed through a threaded hole of the handle 14. The end surface of the screw body of the adjustment screw 20 abuts against the base body 100. The abutting force to the base body 100 can be adjusted by a user adjusting (or rotating) the adjustment screw 20 relative to the handle 14; that is, the drag against the movement of the handle 14 can be adjusted by the adjustment screw 20.

In addition, in the embodiment, the cover 18 has a cover body 180 and a third guiding slot 182 (shown in FIG. 2) formed on the cover body 180 and matching with the first guiding slot 1002. When the cover 18 pivots relative to the base body 100 so that the cover body 180 is opposite right to (or aligned with) the base body 100, the cover body 180 covers the interior of the rope braking device 1 and the third guiding slot 182 is substantially parallel to the first guiding slot 1002 so that the clamping part 16 is also slidably disposed in the third guiding slot 182. Such configuration make the movement of the clamping part 16 relative to the base body 100 more stable. In addition, for convenience of positioning the cover body 180 relative to the base body 100, the base 10 includes a positioning part 102 disposed on the base body 100, and the cover 18 has a positioned recess 184 formed on the cover body 180. When the positioning part 102 is received in the positioned recess 184, the third guiding slot 182 is disposed parallel to the first guiding slot 1002. In the embodiment, the positioning part 102 is a spring plunger while the positioned recess 184 is a through hole. Furthermore, in practice, a screw 104 (shown by dashed lines in FIG. 1) on the base body 100 (as shown in FIG. 1) in coordination with a notch 180a formed at an edge of the cover body 180 also can perform the positioning function as the positioning part 102 in coordination with the positioned recess 184. In addition, the base 10 includes an attachment part 106 connected to the base body 100. The rope braking device 1 can hang through the attachment part 106 on a hook or something that can be attached thereto.

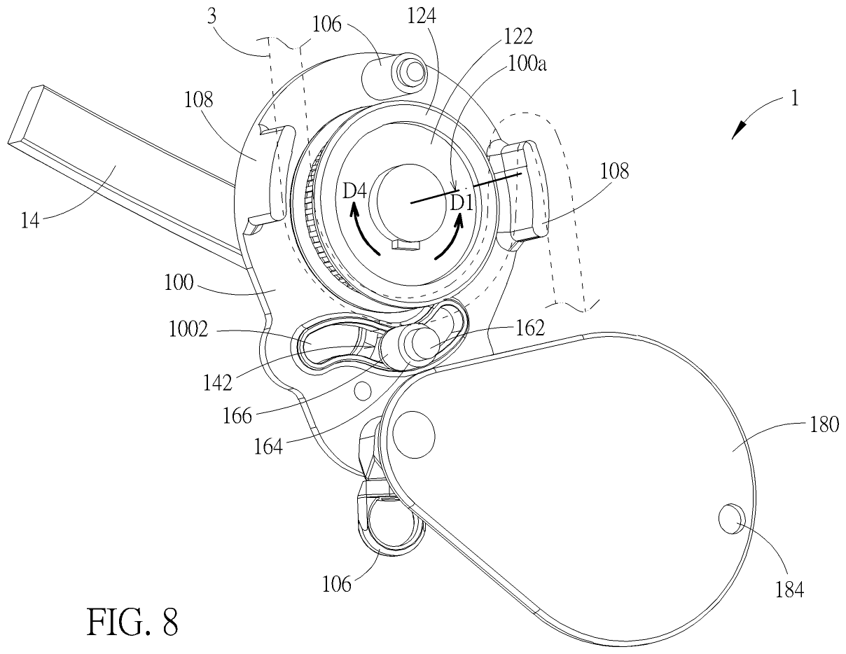

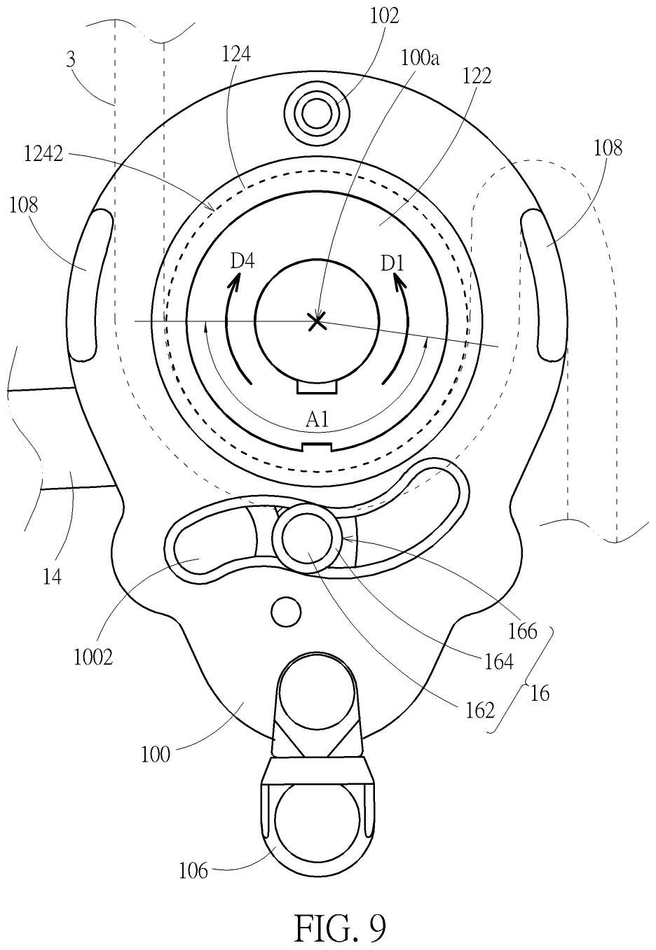

The above description is based on that the rope braking device 1 is used as a pulley; however the invention is not limited thereto. Please refer to FIG. 8 and FIG. 9. The rope braking device 1 is used as a descender, e.g. for a human; therein, the rope braking device 1 is attached firmly with the human through the attachment part 106. The base 10 includes two guiding posts 108 fixedly disposed near the one-way pulley 12 on the base body 100. The rope 3 is also wound around one of the guiding posts 108, so that the rope 3 is capable of being wound around the rotary wheel 124 by a central angle A1 of the rotary wheel 124 over 150 degrees. Furthermore, the two guiding posts 108 also can protect and keep the rope 3 inside the rope braking device 1.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rope braking device, comprising:
a base, comprising a base body and a first guiding slot formed on the base body, the base body thereon defining a rotation center, the first guiding slot extending along a curve path, a distance that is defined from the rotation center to the curve path being variable and having a first relative minimum corresponding to a first position of the curve path;
a one-way pulley, disposed on the base body at the rotation center and having a rotary wheel, the rotary wheel being rotatable in a rotation direction;
a handle, pivotally connected to the base body and having a second guiding slot; and
a clamping part, slidably disposed in the first guiding slot and the second guiding slot simultaneously, the clamping part having a clamping surface opposite to a peripheral surface of the rotary wheel;
wherein a rope is capable of being wound around the rotary wheel and between the peripheral surface and the clamping surface, and when the handle is operable to pivot relative to the base body to make the clamping part move toward the first position until the rope is compressed by the peripheral surface and the clamping surface, the rope is unmovable in a braking direction opposite to the rotation direction and the rope is movable in the rotation direction.

2. The rope braking device of claim 1, wherein the clamping part comprises a shaft and a rotary rim, the shaft passes through the first guiding slot and the second guiding slot and is movable along the first guiding slot and the second guiding slot simultaneously, the rotary rim is rotatably disposed on the shaft, and the rotary rim has the clamping surface.

3. The rope braking device of claim 1, wherein the distance that is defined from the rotation center to the curve path has a second relative minimum corresponding to a second position of the curve path, and when the handle is operable to pivot relative to the base body to make the clamping part move to the second position, the rope is compressed by the peripheral surface and the clamping surface, so that the rope is unmovable in the braking direction and is movable in the rotation direction.

4. The rope braking device of claim 3, wherein the first position is located at an end of the curve path, and the second position is located within a middle section of the curve path.

5. The rope braking device of claim 4, wherein the distance that is defined from the rotation center to the curve path has a first relative maximum corresponding to a third position of the curve path, the second position is located between the first position and the third position, and when the handle is operable to pivot relative to the base body to make the clamping part move to the third position, the rope is free of the clamping surface.

6. The rope braking device of claim 5, wherein the distance that is defined from the rotation center to the curve path has a second relative maximum corresponding to a fourth position of the curve path, the fourth position is located between the first position and the second position, and when the handle is operable to pivot relative to the base body to make the clamping part move to the fourth position, the rope is compressed by the peripheral surface and the clamping surface, so that the rope is movable in the braking direction.

7. The rope braking device of claim 3, wherein when the clamping part is located between the first position and the second position, the rope is compressed by the peripheral surface and the clamping surface and the rope is movable in the braking direction.

8. The rope braking device of claim 1, wherein the peripheral surface is a rough surface.

9. The rope braking device of claim 1, wherein the one-way pulley comprises a plurality of grooves formed on the peripheral surface and extending perpendicular to the rotation direction.

10. The rope braking device of claim 1, wherein the base comprises a guiding post fixedly disposed near the one-way pulley on the base body, and the rope is also wound around the guiding post, so that the rope is capable of being wound around the rotary wheel by a central angle of the rotary wheel over 150 degrees.

11. The rope braking device of claim 1, wherein the base comprises an attachment part connected to the base body.

12. The rope braking device of claim 1, further comprising a cover, pivotally connected to the base body, wherein the one-way pulley is located between the cover and the base body, the cover has a third guiding slot matching with the first guiding slot, and the clamping part is also slidably disposed in the third guiding slot.

13. The rope braking device of claim 12, wherein the base comprises a positioning part disposed on the base body, the cover has a positioned recess, and when the positioning part is received in the positioned recess, the third guiding slot is parallel to the first guiding slot.

14. The rope braking device of claim 1, further comprising an adjustment screw, wherein the adjustment screw is adjustably screwed through the handle and adjustably abuts against the base body.
